(19) United States
(12) Patent Application Publication
(10) Pub. No.: US 2015/0126317 A1
(43) Pub. Date: May 7, 2015

(54) PLANETARY GEAR SELF-ACTUATED CONTROL DRIVE-TYPE CONTINUOUSLY VARIABLE TRANSMISSION MECHANISM

(71) Applicant: Minoru Nakagawa, Yokohama-city (JP)

(72) Inventor: Minoru Nakagawa, Yokohama-city (JP)

(21) Appl. No.: 14/404,382

(22) PCT Filed: Jun. 3, 2013
(86) PCT No.: PCT/JP2013/065902

§ 371 Date: Nov. 26, 2014

(30) Foreign Application Priority Data
Jun. 3, 2012 (JP) 2012-138212

(51) Int. Cl. F16H 29/14; F16H 3/44

(52) U.S. Cl. CPC F16H 29/14; F16H 3/44
USPC 475/16

(57) ABSTRACT

Provided is a planetary gear-type continuously variable transmission mechanism which is capable of smooth continuous variation. A support frame (4), which supports parent/child planet gears (7) provided with a one-way mechanism (10), and push gears (1) that mesh with the small gears of the parent/child planet gears (7) and are provided with power rollers, is provided inside a member in which a ring shaped outer periphery support frame (5) that supports cam arms (2) having cam peaks at the top and bottom thereof, and an outer cam (3) that has cams that push out the cam arms, are meshed by a control gear (6), and a sun gear meshes with the large gears of the parent/child planet gears. The support frame (4) is rotated, pushing the power rollers of the push gears (1) against the inner wall surface of the outer periphery support frame (5), stopping the rotation of the parent/child planet gears (7), thus creating rotational drive and obtaining drive from the sun gear. The cam arms (2) of the outer periphery support frame (5) are pushed out by the rotation of the control gear (6), pushing the push gears (1) in, thus applying rotational drive to the parent/child planet gears (7) and adding rotational force to the sun gear.

### TECHNICAL FIELD

The present invention relates to a continuously variable transmission mechanism among the power transmissions.

### BACKGROUND ART

In the continuously variable transmission mechanism, a practically used belt-type of CVT is a friction transmission between an input and output drive by means of a two-axis configuration, a toroidal-type of CVT is also power roller type of a friction transmission between an input and output drive, there are problems of a lot of a friction loss. Although in the both types a frictional resistance further increases during movement in the transmission range and thereby increasing the friction loss, they has been practically used.

The rotation transmission system in the planetary gear arrangement which has a low frictional resistance is a stepwise shift transmission method by the lock-up means wherein each gear ratio is fixed, and it has been practically insufficient to obtain a continuously variable transmission.

However, although in the input side planetary gear revolution driving method of controlling and driving a ring gear in the planetary gear arrangement, a driving method in which a sun gear is an output power can obtain the highest ratio of speed up, a brake controlling of the rotation of the ring gear during a revolution driving of the planetary gear, or a mechanism of controlling and driving a variable transmission by another power makes it possible to carry out a continuously variable transmission, but there have been disadvantages that frictions or other power load must continue to be added at all times from a stable low geared.

In the use of a continuously variable transmission, if there is not a large friction device or power load device, this disadvantages makes it possible to render a problem that it is impossible to drive and control the ring gear smoothly and continuously.

### PRIOR ART LITERATURE

### Patent Literature

### DISCLOSURE OF THE INVENTION

### Problems to be Resolved by the Invention

The problem to be solved is that in a shift and rotation transmission system by a set of the planetary gear arrangement, a brake controlling of the ring gear, or mechanisms such as those of controlling and driving by another power tends to become complicated and a large-scale, and it is impossible to obtain a continuously variable transmission arrangement from a stable low geared smoothly and simply.

### Means of Solving the Problems

The present invention is a configuration capable of carrying out a continuously variable transmission by an arrangement of a set of planetary gear, for example, as described in Figure, and the most important feature is a continuously variable transmission mechanism wherein an input rotational force, an output side load and a cam arm makes it possible to smoothly and simply carry out a continuously variable transmission from a stable low geared.

### Effect of Invention

A planetary gear self-actuated control drive type continuously variable transmission mechanism according to the present invention makes it possible to carry out a continuously variable transmission by an arrangement of a set of planetary gear, and an input rotational force, an output side load and a cam arm makes it possible to smoothly carry out a continuously variable transmission from a stable low geared by a simple structure. This makes it possible to carry out applications and integration into the various rotary drive transmission and thereby the present invention having an advantage that it is possible to use it for a drive machine which is required for a smaller device than the belt type pf CVT mechanism.

### BRIEF DESCRIPTION OF THE DRAWINGS

FIG. 1 gives an explanatory diagram showing a structure or method of a planetary gear self-actuated control drive type continuously variable transmission mechanism (a ring gear or the like are partially omitted). (Example 1)

FIG. 2 gives a planetary gear self-actuated control drive type continuously variable transmission mechanism wherein the mounting position of the power roller (8) with a push gear (1a, b, c) is changed to reduce the diameter of the outer peripheral support frame (5) etc. (a ring gear, etc., are partially omitted).

FIG. 3 gives a diagram showing a planetary gear self-actuated control drive type continuously variable transmission mechanism wherein the push gear (1a, b, c) is arranged on the opposite side of the parent-child planetary gear (7a, b, c) in FIG. 1 (a ring gear, etc., are partially omitted).

FIG. 4 gives a diagram showing a planetary gear self-actuated control drive type continuously variable transmission mechanism wherein the push gear (1a, b, c) is attached to the axis (12) supported with a support frame (4) for achieving a lever drive (a ring gear, etc., are partially omitted).

FIG. 5 gives a diagram showing a portion of a planetary gear self-actuated control drive type continuously variable transmission mechanism wherein the push gear (1a, b, c) is attached to the axis (12) supported with a support frame (4) for achieving a lever drive on the opposite side of the parent-child planetary gear (7a, b, c) in FIG. 2 (a ring gear, etc., are partially omitted).

### MODE FOR CARRYING OUT THE INVENTION

In order to achieve an object that it is impossible to achieve a continuously variable transmission by a set of the planetary gear arrangement, the parent-child planetary gear control drive by the input rotational force through an output side load and a cam arm (2a, b, c, d) makes it possible to make change and carry out a continuously variable transmission.

### EXAMPLE 1

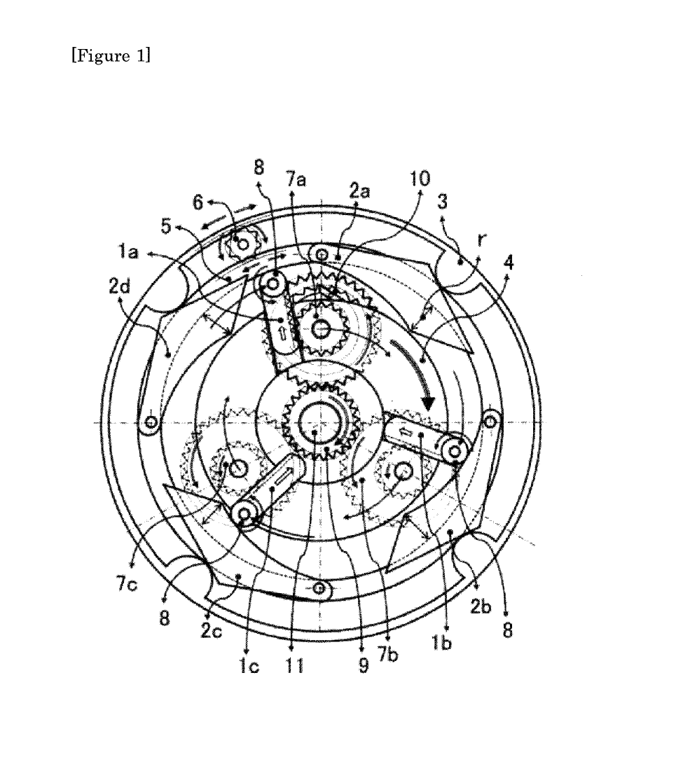

FIG. 1 is a diagram showing a high geared region of an example of a planetary gear self-actuated control drive type continuously variable transmission mechanism according to the present invention (a ring gear, etc., are partially omitted), it is shown that 1a, b, c are a push gear, 2a, b, c, d are a cam arm, 3 is an outer cam, 4 is a support frame of the input side, 5 is an outer circumferential support frame, 6 is a control gear, 7a, b, c are a parent-child planetary gear with one-way mechanism, 8 is a power roller, 9 is a sun gear of the output side, 10 is a one-way mechanism of a parent-child planetary gear, 11 is a central axis, 12 is an axis supported by the support frame, r is an amount of lift.

A push gear (1a, b, c) with a power roller is meshed with the small gear of the a parent-child planetary gear (7a, b, to be able to carry out a reciprocating motion by the one-way mechanism (10). Both are supported by the support frame (4), a cam arm (2a, b, c, d) with cam mounts on the above and below is supported by an outer circumferential support frame (5), a control gear (6) and an outer cam (3) makes it possible to push and change a lift amount of a cam arm shown as r.

By an input rotation of a support frame (4) indicated as an arrow direction, an input rotational force as indicated by the arrow is transmitted to the large gear of the parent-child planetary gear (7a, b, c) and the small gear of the parent-child planetary gear (7a, b, c) via the one-way mechanism (10) through the load at the output side of the sun gear (9) to push the engaged push gear (1a, b, c) to the direction of an outer circumference. And the power roller (8) is pushed and stopped with a surface of the inner wall of the outer circumferential support frame (5) to rotate it integral with the support frame (4). And the input rotation by offsetting the load at the output side with a surface of the inner wall of the outer circumferential support frame (5) makes it possible to attain a stop of the reciprocating motion of the push gear (1a, b, c) to obtain a revolution drive wherein the rotation of the parent-child planetary gear (7a, b, c) is forcibly stopped.

The control gear (6) and the outer cam (3) push a cam arm (2a, b, c, d), every time the power roller (8) passes through the surface of the inner wall of the outer circumferential support frame (5) and the cam arm (2a, b, c, d), the reciprocating drive of the push gear is carried out through the one-way mechanism (10), and an addition of the forcible driving force of the rotation to the parent-child planetary gear (7a, b, c) continuously makes it possible to control the rotation and revolution drive of the large gear of the parent-child planetary gear (7a, b, c) universally.

In FIGS. 1, in the input which the cam arm (2a, b, c, d) is pushed at a lift amount indicated as r, the input rotation power makes it possible to push the push gear (1a, b, c) to a direction indicated as the arrow every time the each power roller (8) passes through the cam arm (2a, b, c, d), the reciprocating drive of the push gear is sequentially carried out through the one-way mechanism (10) to carry out the rotation drive of the small gear of the parent-child planetary gear (7a, b, c) to the opposite direction of the input indicated as the arrow, and thereby adding the rotation drive power of the opposite direction of the input to the large gear of the parent-child planetary gear (7a, b, c) wherein both the rotation and revolution is carried out through the one-way mechanism (10) to accelerate the speed additionally and continuously to the rotation of the input direction of the sun gear (9) at the output side. And then, it is possible to obtain a high geared region (a ring gear is driven to the stop region late slowly than the input one-on-one rotation).

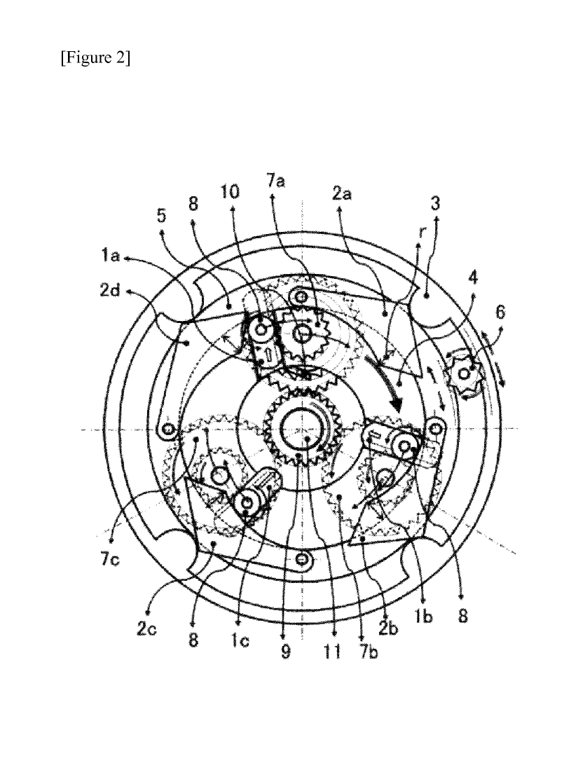

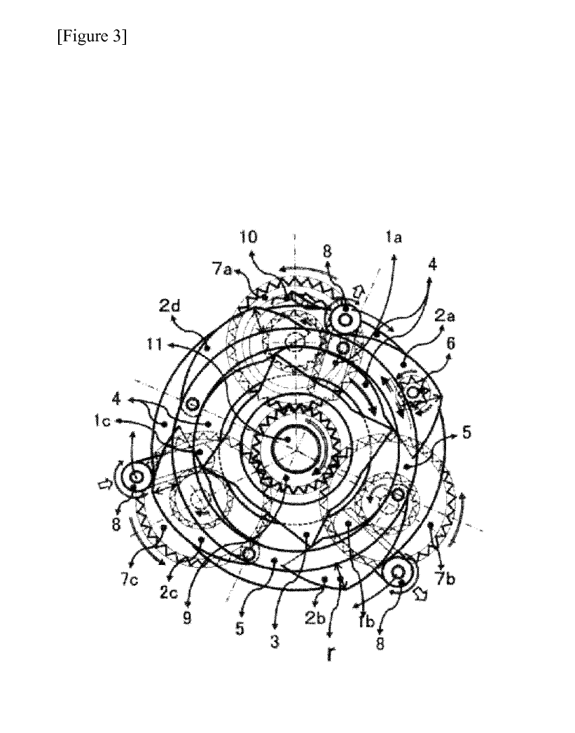

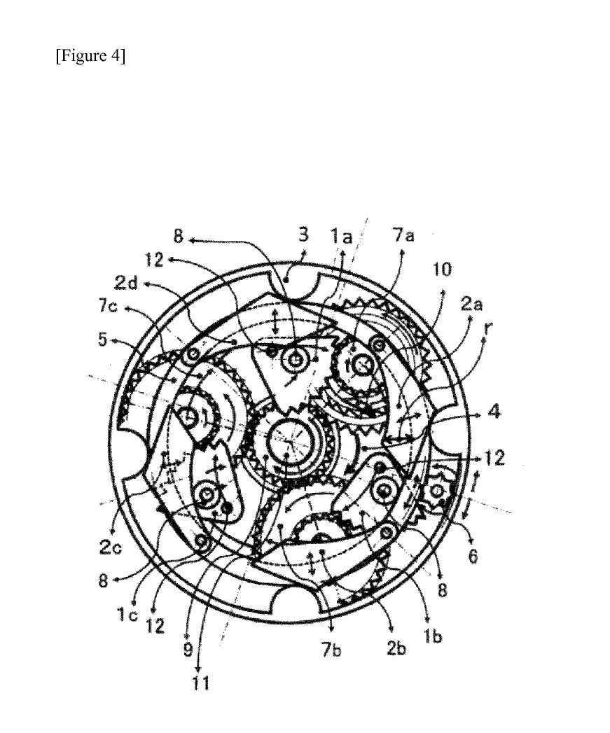

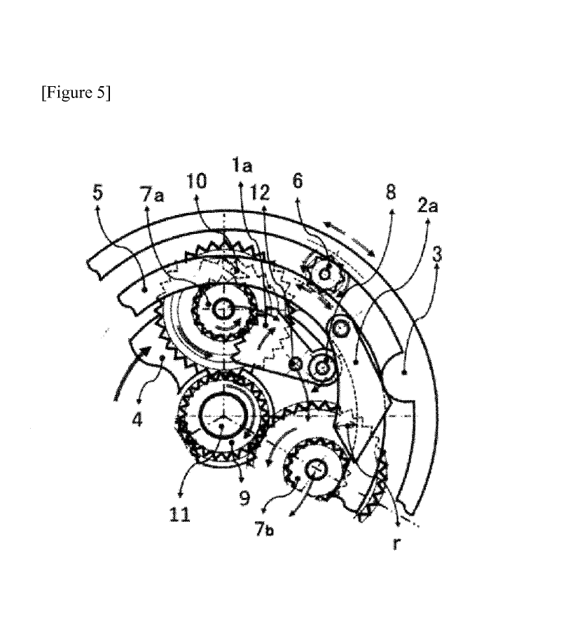

FIG. 2 is also driven similarly. In FIG. 4, the push gear (1a, b, c) is driven similarly to a direction of the central axis wherein an axis (12) supported by the support frame (4) is used as the supporting point, in FIG. 3, the push gear (1a, b, c) is driven to an opposite direction of the central axis wherein an axis (12) supported by the support frame (4) is used as the supporting point, and in FIG. 5, each power roller (8) is driven to a direction of the central axis and the push gear (1a, b, c) is driven to a direction of the outer circumference wherein an axis (12) supported by the support frame (4) is used as the supporting point.

In FIG. 1, in the input wherein the cam arm (2a, b, c, d) is stored within the outer circumferential support frame (5) by the rotary drive of the outer cam (3) to the right direction of the arrow and the rotary drive of the outer circumferential support frame (5) by means of the control gear (6), the input rotation power makes it possible to rotate the small gear of the parent-child planetary gear (7a, b, c) through the one-way mechanism (10) form the parent-child planetary gear (7a, b, c) meshing the sun gear at the output side (9) to push the meshed push gear (1a, b, c) to a direction of the outer circumference and thereby the power roller (8) being pushed and stopped to the surface of the inner wall of the outer circumferential support frame (5) to stop the reciprocating motion of the push gear (1a, b, c) to attain an input drive on one-on-one level. And then, the revolution drive wherein the rotation of the meshed push gear (7a, b, c) is stopped makes it possible to obtain a stable low geared wherein it is driven with an input on one-on-one level, through an input drive on one-on-one level wherein the parent-child planetary gear (7a, b, c) is engaged with the meshed sun gear at the output side and a ring gear.

The rotating and driving means of the outer cam (3) and an outer circumferential support frame (5) according to this control gear (6) makes it possible to attain a change of the lift amount of the cam arm (2a, b, c, d) to change of both high geared region and low geared region instantly with smaller resistance even if it is during an input or a state of stopping an input.

In FIG. 1, a basic drive arrangement of the present invention is shown, a drawing of the ring gear and the explanation in the written description are omitted for convenience. In the implementation, except that the drive rotation of the parent-child planetary gear (7a, b, c) is smooth and the integration of the ring gear is difficult (means such as to engage the ring gear by attaching a pinion gear newly to each parent-child planetary gear), the engaging of the ring gear omitted in FIG. 1 or FIGS. 2, 3, 4 and 5 to the parent-child planetary gear (7a, b, c) makes it possible to carry out the overdrive by attaching a temporary rotation lock function to the ring gear, a full automatic continuously variable transmission can be obtained by an electronic or mechanical control of the control gear (6).

An overall outer circumference diameter can be small in FIG. 1, or FIG. 3 wherein the push gear (1a, b, c) is arranged on the opposite side of the parent-child planetary gear (7a, b, c), or a constitution arranged to the side of the parent-child planetary gear (7a, b, c) by making a diameter of an outer circumferential support frame (5) small etc., since it is able to be a chassis fix of the outer cam (3), a chassis fix of the outer circumferential support frame (5), a direct rotation and drive of the outer cam (3) and a planetary gear arrangement, it is possible to change a member or position to some extent. It is possible to change an integration that a gear ratio of the parent-child planetary gear (7a, b, c) is large and a gear diameter of the sun gear (9) is small, an integration of other one-way mechanism etc., a shape of cam of the cam arm (2a, b, c, d), a size of each member, a shape, a number, an angle or portion for attaching, a member for supporting them, a bearing, a return spring, according to the applications.

### INDUSTRIAL APPLICABILITY

It is possible to apply it as a new another application comparing with two axes type of CVT by the friction drive, since it is a continuously variable transmission which is a set of the planetary gear arrangement by the one central axis, and is simple and a small size with no loss of friction.

### DESCRIPTION OF THE REFERENCE NUMERALS

1a, b, c a push gear

2a, b, c, d a cam arm

3 an outer cam

4 a support frame

5 an outer circumferential support frame

6 a control gear

7a, b, c a parent-child planetary gear with one-way mechanism

8 a power roller

9 a sun gear

10 a one-way mechanism

11 a central axis

12 an axis (Supported by the support frame)

r an amount of lift

1. A planetary gear self-actuated control drive type continuously variable transmission mechanism, wherein it comprises instead of a control drive by a ring gear in a planetary gear configuration, a member of meshing a ring type of an outer circumferential support frame supporting a cam arm with a cam mount on the above and below and an outer cam with a control gear,
a parent-child planetary gear with an one-way mechanism,
a support frame at an input side for supporting a push gear with a power roller to mesh a small gear of the parent-child planetary gear to achieve a reciprocating drive,
and a sun gear at an output side is meshed to a large gear of the parent-child planetary gear, and wherein a drive power of an input direction of the parent-child planetary gear by an input of a support frame through a load of the sun gear at an output side allows the push gear to push to an outer circumference,
and the power roller is pushed on a surface of an inner wall of the outer circumferential support frame to obtain a revolution drive integrated with the support frame wherein the rotation of the parent-child planetary gear is stopped through the stop drive of a reciprocating drive of the push gear integrated with the support frame, and thereby attaining an input drive on one-on-one level of the sun gear at the output side, and
the cam arm is pushed by a rotation and drive of the control gear, an input rotation power of the support frame allows the push gear by the power roller passing the cam arm to be pushed to achieve a reciprocating drive through the one-way mechanism to add a rotation drive power to an opposite direction of the input rotation to the parent-child planetary gear sequentially to add the rotation power in the input direction to the sun gear at the output side, and
wherein the control of the rotation and revolution of the parent-child planetary gear is universally carried out by the input rotation power through the load at the output side and the cam arm.
